(19) United States
(12) Patent Application Publication
(10) Pub. No.: US 2023/0409110 A1
(43) Pub. Date: Dec. 21, 2023

(54) INFORMATION PROCESSING APPARATUS, INFORMATION PROCESSING METHOD, COMPUTER-READABLE RECORDING MEDIUM, AND MODEL GENERATING METHOD

(71) Applicant: Sony Group Corporation, Tokyo (JP)

(72) Inventor: Shunichi KASAHARA, Kanagawa (JP)

(73) Assignee: Sony Group Corporation, Tokyo (JP)

(21) Appl. No.: 18/036,575

(22) PCT Filed: Nov. 1, 2021
(86) PCT No.: PCT/JP2021/040244

§ 371 Date: May 11, 2023

(30) Foreign Application Priority Data
Nov. 18, 2020 (JP) 2020-191693

(51) Int. Cl. G06F 3/01

(52) U.S. Cl. CPC G06F 3/013

(57) ABSTRACT

An information processing apparatus according to an embodiment of the present technology includes an acquisition unit and an output unit. The acquisition unit acquires data relating to an input object as a visual object. The output unit outputs, on the basis of a model representing a relationship between a distance in a latent space relating to the visual object and a degree of recognition with respect to a change of the visual object based on the distance, at least one of data relating to at least one change object in which the input object is changed in the latent space in accordance with instruction information including an instruction value relating to the degree of recognition, or a cognitive parameter representing the degree of recognition with respect to a change from the input object to a reference object corresponding to the input object.

### TECHNICAL FIELD

The present technology relates to an information processing apparatus, an information processing method, a computer-readable recording medium, and a model generating method, which are applicable to generation of content in which display contents change.

### BACKGROUND ART

Conventionally, the technology of changing a display object displayed on a display or the like has been developed. For example, Patent Literature 1 discloses a method of changing a display object that is displayed to a communication partner in remote communications. In this method, for example, a captured image obtained by capturing an image of a space in which a user is located is displayed as a display object to the other party. At that time, when the other party does not watch the display object, the appearance of the display object is corrected. This makes it possible to decorate the space in which the user is located or the user him/herself without being noticed by the other party (paragraphs [0025], [0054], and [0058] of the specification, FIG. 6, and the like of Patent Literature 1).

### CITATION LIST

### Patent Literature

Patent Literature 1: WO2019/176236

### DISCLOSURE OF INVENTION

### Technical Problem

Even if a display object is corrected at a timing at which a user does not watch the display object as described above, there is a possibility that the correction itself is conspicuous depending on the degree of change of the display object. Thus, there is a need for a technology capable of providing content in which display contents change without being noticed by the user.

In view of the circumstances as described above, it is an object of the present technology to provide an information processing apparatus, an information processing method, a computer-readable recording medium, and a model generating method, which provide content in which display contents change without being noticed by a user.

### Solution to Problem

In order to achieve the above object, an information processing apparatus according to an embodiment of the present technology includes an acquisition unit and an output unit.

The acquisition unit acquires data relating to an input object as a visual object.

The output unit outputs, on the basis of a model representing a relationship between a distance in a latent space relating to the visual object and a degree of recognition with respect to a change of the visual object based on the distance, at least one of data relating to at least one change object in which the input object is changed in the latent space in accordance with instruction information including an instruction value relating to the degree of recognition, or a cognitive parameter representing the degree of recognition with respect to a change from the input object to a reference object corresponding to the input object.

In this information processing apparatus, the data relating to the change object or the cognitive parameter is output using the model in which the degree of recognition with respect to the change of the visual object is associated with the distance in the latent space. The change object is an object obtained by changing the input object in accordance with the instruction information of the degree of recognition. Further, the cognitive parameter is a value representing the degree of recognition, which represents a change from the input object to the reference object. Use of the data relating to the change object and the cognitive parameter makes it possible to provide content in which display contents change without being noticed by the user.

The instruction value may be a threshold of the degree of recognition. In this case, the at least one change object may be an object switched for display in a predetermined order instead of the input object. Further, the output unit sets a distance in the latent space, which corresponds to an amount of change of a visual change caused by switching the change object for display, such that the degree of recognition with respect to the visual change caused by switching the change object for display does not exceed the threshold of the degree of recognition.

The output unit may set the distance in the latent space, which corresponds to the amount of change, to a maximum value in a range in which the degree of recognition with respect to the visual change caused by switching the change object for display does not exceed the threshold of the degree of recognition.

The predetermined order may be an order of a shorter distance in the latent space between the input object and the change object.

The output unit may output the data relating to the at least one change object in which the input object is changed to approach the reference object corresponding to the input object in the latent space.

The instruction information may include information for instructing a change direction, in which the input object is changed, in the latent space. In this case, the output unit may output the data relating to the at least one change object in which the input object is changed along the change direction in the latent space.

The latent space may be a feature amount space configured by at least one feature amount relating to the visual object. In this case, the instruction information may be information for instructing the change direction by the at least one feature amount.

The information processing apparatus may further include a display control unit that controls a display apparatus to display a target object to be displayed in the input object and the at least one change object, detects a state in which visual change blindness is caused to a user who views the target object, and controls the display apparatus to change the target object to the change object to be displayed next in accordance with a timing at which the visual change blindness has been caused.

The state in which the visual change blindness is caused may include at least one of a state in which the user closes an eye, a state in which the target object is inhibited from being displayed, or a state in which a display parameter of the target object is changed.

The output unit may output, as the cognitive parameter, a change detection rate with respect to an overall visual change caused by changing the input object to the reference object.

The output unit may output a first change detection rate with respect to a visual change associated with first change processing of changing the input object to the reference object at one time.

The output unit may output a second change detection rate with respect to a visual change associated with second change processing including a plurality of division change processes of changing the input object to the reference object a plurality of times.

The output unit may multiply a division change detection rate with respect to a visual change associated with each of the plurality of division change processes, to calculate the second change detection rate.

The acquisition unit may acquire a threshold of the second change detection rate.

The output unit may set the number of times of the plurality of division change processes and an amount of change in each of the plurality of division change processes such that the second change detection rate is equal to or smaller than the threshold of the second change detection rate.

The reference object may be an object input by a user or an object obtained by changing the input object in accordance with an amount of change input by the user.

The model may include a plurality of pieces of graph data each indicating the degree of recognition with respect to the change of the visual object based on the distance in the latent space in each of change directions mutually different in the latent space.

The plurality of pieces of graph data may include data generated for each of human characteristics. In this case, the output unit may select data matched with a characteristic of a user from the plurality of pieces of graph data.

An information processing method according to an embodiment of the present technology is an information processing method executed by a computer system, the information processing method including: acquiring data relating to an input object as a visual object; and outputting, on the basis of a model representing a relationship between a distance in a latent space relating to the visual object and a degree of recognition with respect to a change of the visual object based on the distance, at least one of data relating to at least one change object in which the input object is changed in the latent space in accordance with instruction information including an instruction value relating to the degree of recognition, or a cognitive parameter representing the degree of recognition with respect to a change from the input object to a reference object corresponding to the input object.

A computer-readable recording medium according to an embodiment of the present technology records thereon a program causing a computer system to execute processing, the processing including the following steps of: acquiring data relating to an input object as a visual object; and outputting, on the basis of a model representing a relationship between a distance in a latent space relating to the visual object and a degree of recognition with respect to a change of the visual object based on the distance, at least one of data relating to at least one change object in which the input object is changed in the latent space in accordance with instruction information including an instruction value relating to the degree of recognition, or a cognitive parameter representing the degree of recognition with respect to a change from the input object to a reference object corresponding to the input object.

A model generating method according to an embodiment of the present technology is a model generating method executed by a computer system, the model generating method including: generating data relating to each of a first visual object and a second visual object that are represented by different points in a latent space relating to a visual object; acquiring data in which a determination result of a test is associated with a distance between the points representing the first visual object and the second visual object in the latent space, the test being for allowing a tester to determine presence or absence of a cognitive difference between the first visual object and the second visual object or a degree of the cognitive difference; and generating a model representing a relationship between the distance in the latent space and a degree of recognition with respect to a change of the visual object based on the distance on the basis of the acquired data.

### BRIEF DESCRIPTION OF DRAWINGS

FIG. 1 is a schematic view showing the outline of a content generation system according to an embodiment of the present technology.

FIG. 2 is a block diagram showing a configuration example of the content generation system.

FIG. 3 is a schematic view for describing change blindness.

FIG. 4 is a schematic view showing an example of a latent space relating to a visual object.

FIG. 5 is a schematic view for describing a method of generating a latent cognitive scale.

FIG. 6 is a schematic view showing an example of a graph constituting the latent cognitive scale.

FIG. 7 is a schematic view showing examples of scale graphs with different change directions.

FIG. 8 is a schematic view showing an example of the change direction in the latent space.

FIG. 9 is a flowchart showing an example of a change object output processing.

FIG. 10 is a schematic view for describing the change object output processing.

FIG. 11 is a flowchart showing an example of cognitive parameter output processing.

FIG. 12 is a schematic view for describing the cognitive parameter output processing.

FIG. 13 is a schematic view showing another example of the cognitive parameter output processing.

FIG. 14 is a schematic view showing an example of content generated using an authoring tool to which the content generation system is applied.

FIG. 15 is a schematic view showing an example of a design screen of the authoring tool.

FIG. 16 is a schematic view showing a use example of a video communication tool to which the content generation system is applied.

FIG. 17 is a schematic view showing an example of a setting screen relating to correction of face information.

### MODE(S) FOR CARRYING OUT THE INVENTION

Hereinafter, an embodiment according to the present technology will be described with reference to the drawings.

[Configuration of Visual Content Generation System]

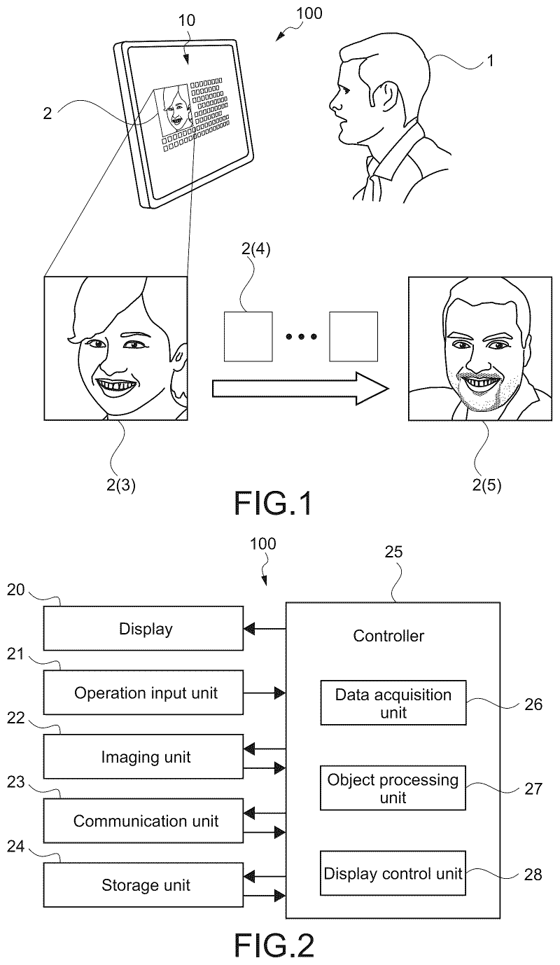

FIG. 1 is a schematic view showing the outline of a content generation system according to an embodiment of the present technology. A content generation system 100 is a system that generates visual content 10 for presenting various types of visual information to a user 1.

The visual content 10 includes a visual object 2 that the user 1 can see by the eyes. For example, the objects that can be seen by the eyes, such as photographs, graphics, letters, and drawings, are the visual objects 2. The visual content 10 is configured by combining those visual objects 2.

In the example shown in FIG. 1, the visual content 10 including a portrait image and letters as the visual objects 2 is displayed on a display 20.

In this embodiment, the content generation system 100 generates visual content 10 in which the visual objects 2 serving as display contents change.

The lower part of FIG. 1 schematically illustrates a state in which the visual object 2 changes.

First, an input object 3 (portrait image of a woman) as the visual object 2 is displayed. Here, the input object 3 is a visual object 2 to be processed by the content generation system 100. In this case, processing of visually changing the input object 3 is performed.

After the input object 3 is displayed, at least one change object 4, which is obtained by changing the input object 3, is switched for display in a predetermined order instead of the input object 3.

A reference object 5 (portrait image of a man) corresponding to the input object 3 is eventually displayed in the part in which the input object 3 has been displayed.

Display switching between the objects is performed, for example, at a timing at which visual change blindness occurs, the visual change blindness making it difficult for the user 1 to recognize a visual change. This makes it possible to change the display contents without being noticed by the user 1. The visual change blindness will be described later in detail.

The data relating to each change object 4 obtained by changing the input object 3 is output using a latent space relating to the visual object 2.

Here, the latent space is, for example, a high-dimensional vector space including a large number of latent variables expressing the visual object 2. Each point in the latent space corresponds to a visual object 2 having a different latent variable.

For the output of the data relating to the change object 4, a latent space capable of representing the input object 3, that is, setting a point corresponding to the input object 3 is used.

For example, by learning of an image (visual object 2) representing a similar motif (person, landscape, food, or the like), a latent space corresponding to each motif can be configured. In this case, the data relating to the change object 4 is output using the latent space corresponding to the motif of the input object 3.

In the example shown in FIG. 1, for example, a latent space relating to a portrait image is used.

Note that it is not always necessary to form a latent space for each motif. For example, a general-purpose latent space or the like capable of representing general images may be used.

Further, a latent space corresponding to the type of the visual object 2 (photographs, graphics, letters, drawings, and the like) may be used, or a latent space encompassing various types may be used.

For example, the input object 3 changes by moving a point corresponding to the input object 3 in the latent space. The amount of change thereof is a distance obtained by moving the point corresponding to the input object 3. Therefore, the amount of change of a visual change caused by switching the change object 4 for display (that is, the amount of change of a visual change before and after the switching) can be expressed as the distance in the latent space.

In the content generation system 100, visual content is generated using a model representing a relationship between the distance in the latent space relating to the visual object 2 and the degree of recognition with respect to a change of the visual object 2 based on the distance.

This model can be said to be a scale that defines the degree of recognition with respect to a visual change of the visual object 2 by using the distance in the latent space relating to the visual object 2. Hereinafter, this model will be referred to as a latent cognitive scale.

Use of the latent cognitive scale makes it possible to output data relating to the change object 4 in which the degree of recognition with respect to the visual change caused by the switching of the object is controlled, or to predict the degree of recognition with respect to the visual change caused by the switching of the object.

The latent space and the latent cognitive scale will be described later in detail.

FIG. 2 is a block diagram showing a configuration example of the content generation system. The content generation system 100 includes a display 20, an operation input unit 21, an imaging unit 22, a communication unit 23, a storage unit 24, and a controller 25.

The display 20 is a display apparatus that displays an image. Data of a content screen, which is generated by the controller 25 to be described later, is input to the display 20. Here, the content screen is a screen for displaying the visual content 10. The content screen includes various visual objects 2. Hereinafter, the visual object 2 displayed on the content screen (display 20) will be referred to as a display object.

For the display 20, for example, a liquid crystal display (LCD) including a liquid crystal display element, an organic EL display, and the like are used. Other than those above, a specific configuration of the display 20 is not limited. In this embodiment, the display 20 corresponds to a display apparatus.

The operation input unit 21 is an input device that receives an operation input of the user 1. The user 1 can operate the content screen or input various types of data by operating the operation input unit 21.

For the operation input unit 21, for example, a mouse, a keyboard, and the like are used. In addition, a touch panel, an input device using a line of sight, and the like may be used.

The imaging unit 22 is a camera that images the user 1. The imaging unit 22 is, for example, provided to an outer edge of the display 20. Alternatively, the imaging unit 22 configured as a single device may be used separately from the display 20. In this case, the imaging unit 22 is provided at a position where the user 1 can be imaged from the front.

For the imaging unit 22, a digital camera including an image sensor such as a CMOS or a CCD is used.

The communication unit 23 is a module for executing network communication, short-range wireless communication, and the like with other devices. For the communication unit 23, for example, a radio LAN module for WiFi or the like, or a communication module for Bluetooth (registered trademark) or the like is provided. In addition, a communication module or the like capable of performing communication by wired connection may be provided.

The storage unit 24 is a nonvolatile storage device. For the storage unit 24, for example, a recording medium using a solid-state element such as a solid state drive (SSD) or a magnetic recording medium such as a hard disk drive (HDD) is used. In addition, the type or the like of the recording medium used as the storage unit 24 is not limited, and for example, any recording medium for recording data in a non-transitory manner may be used.

The storage unit 24 stores a control program according to this embodiment. The control program is, for example, a program that controls the overall operation of the content generation system 100.

Further, the storage unit 24 stores data of various visual objects 2 constituting the visual content and data of the latent cognitive scale described above. In addition, the information stored in the storage unit 24 is not limited.

In this embodiment, the storage unit 24 corresponds to a computer-readable recording medium on which programs are recorded. Further, the control program corresponds to a program recorded on the recording medium.

The controller 25 controls the operation of the content generation system 100. The controller 25 has a hardware configuration necessary for a computer, such as a CPU and memories (RAM, ROM). Various types of processing are executed by the CPU loading the control program stored in the storage unit 24 into the RAM and executing the control program. The controller 25 corresponds to an information processing apparatus according to this embodiment.

For example, a programmable logic device (PLD) such as a field programmable gate array (FPGA) or other devices such as an application specific integrated circuit (ASIC) may be used as the controller 25. Further, for example, a processor such as a graphics processing unit (GPU) may be used as the controller 25.

In this embodiment, the CPU of the controller 25 executes the program (control program) according to this embodiment, so that a data acquisition unit 26, an object processing unit 27, and a display control unit 28 are implemented as functional blocks. Those functional blocks perform an information processing method according to this embodiment. Note that dedicated hardware such as an integrated circuit (IC) may be appropriately used in order to implement each functional block.

The data acquisition unit 26 acquires various types of data necessary for generating the visual content 10. For example, data, setting values, and the like stored in the storage unit 24 are read. Further, for example, data, setting values, and the like input to the content screen or the like by the user 1 using the operation input unit 21 are read. Further, for example, a data value or the like for generating the visual content 10 may be read from another device via a network to which the communication unit 23 is connected.

In this embodiment, the data acquisition unit 26 acquires data relating to the input object 3 that is the visual object 2. The data relating to the input object 3 is data (image data or the like) capable of representing the input object 3. As shown in FIG. 1, the input object 3 is an object (initial object) that is a source of a change object.

For example, data of the visual object 2 stored in the storage unit 24, the visual object 2 input by the user 1, or the visual object 2 generated by another device, and the like are read as the data relating to the input object 3.

Further, the data acquisition unit 26 acquires data relating to the reference object 5 corresponding to the input object 3. The reference object 5 is an object (final object) that is finally displayed by changing the input object 3. The data relating to the reference object 5 is data (image data or the like) capable of representing the reference object 5. Note that the input object 3 is changed without setting the reference object 5 in some cases.

Further, the data acquisition unit 26 acquires instruction information for generating the visual content 10.

In this embodiment, the instruction information includes an instruction value relating to the degree of recognition with respect to a change of the visual object 2. This is a parameter indicating the degree to which the change of the visual object 2 is recognized by the user 1. The instruction value relating to the degree of recognition is set as, for example, a detection rate of a change of the visual object 2 and a concealment rate (stealth rate) of a change of the visual object 2. For example, as the detection rate becomes higher (or as the concealment rate becomes lower), the change of the visual object 2 becomes easier to be noticed by the user 1.

Further, the instruction information includes information indicating a change direction in which the input object 3 is changed, and the like. The change direction is specified as a vector in the latent space, for example. Alternatively, when the reference object 5 is used, the direction from the input object 3 toward the reference object 5 in the latent space is the change direction. In this case, the information of the reference object 5 is information indicating the change direction.

Typically, a value set by the user 1 is appropriately read as the instruction information. Alternatively, a preset default value may also be read as the instruction information.

In this embodiment, the data acquisition unit 26 corresponds to an acquisition unit.

The object processing unit 27 outputs data relating to at least one change object 4, in which the input object is changed in the latent space in accordance with the instruction information including the instruction value relating to the degree of recognition, on the basis of the latent cognitive scale. The data relating to the change object 4 is data (image data or the like) capable of representing the change object 4.

The direction in which the input object 3 is changed is the direction acquired as the instruction information. Further, the amount of change of each change object 4 is set on the basis of the latent cognitive scale such that the degree of recognition with respect to the visual change caused by switching the change object 4 for display satisfies the condition indicated by the instruction information (instruction value).

Further, the object processing unit 27 outputs a cognitive parameter representing the degree of recognition with respect to a change from the input object 3 to the reference object 5 corresponding to the input object 3 on the basis of the latent cognitive scale. Here, the change from the input object 3 to the reference object 5 means a visual change in the entire process in which the input object 3 finally changes to the reference object 5. Therefore, it can be said that the cognitive parameter is, for example, a parameter indicating a degree to which the user 1 notices (or a degree to which the user 1 does not notice) that the input object 3 has changed to the reference object 5.

In this embodiment, both the processing of calculating and outputting the data relating to the change object 4 and the processing of calculating and outputting the cognitive parameter are performed. Note that depending on a tool used to generate the content, either one of the processing may be performed.

Hereinafter, the processing of outputting the data relating to the change object 4 and the processing of outputting the cognitive parameter may be referred to as change object output processing and cognitive parameter output processing, respectively.

In this embodiment, the object processing unit 27 corresponds to an output unit.

The display control unit 28 controls display by the display 20. Specifically, the display control unit 28 generates a content screen (visual content 10) displayed on the display 20 and changes the display contents thereof.

In the processing of changing the display contents, the display control unit 28 controls the display 20 to display a target object to be displayed among the input object 3 and at least one change object 4. Specifically, a content screen including the target object is generated and output to the display 20.

Further, the display control unit 28 detects a state in which visual change blindness is caused to the user 1 who views the target object. The display 20 is then controlled so as to change the target object to a change object 4 to be displayed next in accordance with the timing at which visual change blindness occurs. In other words, a content screen including the change object 4 to be displayed next is generated and is output to the display 20 at the timing at which visual change blindness occurs.

Here, the visual change blindness refers to human characteristics in which a human does not notice (or is less likely to notice) a change of an object that the human visually recognizes under a specific condition. Therefore, a state in which visual change blindness is caused to the user 1 can be a state in which the change is less likely to be noticed before and after the target object is changed.

By using this characteristics, the display of the target object (input object 3 or change object 4) can be switched in a state in which the user 1 is less likely to notice the change within the screen.

The state in which visual change blindness is caused is, for example, a state in which the user 1 closes the eyes. Here, the display control unit 28 shown in FIG. 2 detects the moment at which the user 1 blinks or the user 1 closes the eyes completely, from the image of the user 1. At the timing at which the user 1 closes the eyes, each visual object 2 included in the visual content 10 is switched stepwise. Therefore, for example, each time the user 1 blinks, the contents of an article change stepwise, and the article is finally replaced with another article.

Note that another state may be used as the state in which visual change blindness is caused.

For example, a state in which the display of the target object is inhibited may be used as the state in which visual change blindness is caused. In this case, for example, a visual object 2 that is obscured by being blocked by another window or the like is detected, and the detected visual object 2 is switched stepwise.

Further, for example, a state in which the display parameter of the target object is changed may be used as the state in which visual change blindness is caused. For example, when the user 1 performs an operation such as scrolling or zooming, a visual object 2 whose display parameters such as a display position and a display size are changed is detected, and the detected visual object 2 is switched stepwise.

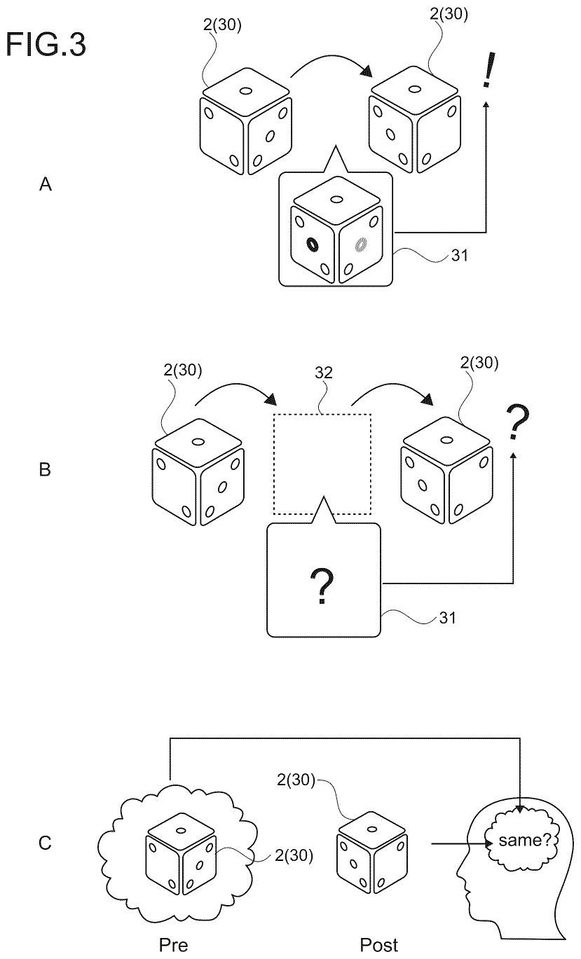

FIG. 3 is a schematic view for describing the change blindness.

A of FIG. 3 schematically illustrates a state in which the visual object 2 changes while the user 1 is gazing at the visual object 2. Here, as shown on the upper side of A of FIG. 3, the image of a die 30 is changed as the visual object 2. Each die 30 is drawn such that the left side surface on the left side in the figure, the right side surface on the right side in the figure, and the upper surface that connects the left and right side surfaces are visible.

In the image of the die 30 before the change, two points are drawn on the left side surface, and three points are drawn on the right side surface. In the image of the die 30 after the change, three points are drawn on the left side surface, and two points are drawn on the right side surface, thus showing the positional relationship opposite to that before the change.

In A of FIG. 3, the image of the die 30 is switched while the user 1 is gazing at the image of the die 30. In this case, the user 1 visually recognizes, on the left side surface, a change in which a point is newly added between the two points. Further, the user 1 visually recognizes, on the right side surface, a change in which the middle point of the three points disappears. The state in which a point is added to each surface or a point disappears is perceived as a visual transient state (visual transient).

As described above, if the visual information (visual object 2) is updated, visual change information 31 (visual transient state) is generated when the image changes, which always attracts the attention of the user 1. As a result, a situation in which the user 1 is easily aware of the change of the visual object 2 is generated.

In this regard, using an apparatus or a visual change that prevents the visual change information 31 from being generated, it is possible to generate a visual change without causing the user 1 to perceive a change such as a visual transient state. As a method of reducing the visual change information 31, a method of utilizing the visual change blindness caused to the user 1 is exemplified.

B of FIG. 3 schematically illustrates a state in which the visual object 2 is changed to generate visual change blindness to the user 1. Here, as in A of FIG. 3, it is assumed that the points drawn on the side surface of the die 30 change.

First, the image of the die 30 before change is displayed. Next, a blank image 32 in which the die 30 is not drawn is displayed for a predetermined period of time. Subsequently, the image of the die 30 after change in which the numbers of points on the left side surface and the right side surface are changed is drawn.

Thus, the user 1 does not perceive the visual transient state as shown in A of FIG. 3. As a result, the visual change information 31 does not occur.

C of FIG. 3 is a schematic view for describing the recognition process of the user 1 with respect to the change of the visual object 2. In the present disclosure, recognizing the change of the visual object 2 (visual change recognition) means that, for example, the user 1 recognizes the visual objects 2 before and after the change, and compares the recognition results, to notice the change of the visual object 2. This corresponds to viewing addition or disappearance (visual transient state) of the points of the dice 30 by the eyes, which is different from perceiving a change in the image (visual motion perception), for example.

First, the visual object 2 before the change is recognized by the user 1, and various types of information regarding the visual object 2 are generated in the brain of the user 1. The information generated at that time includes information such as visual short term memory that is an image of the visual object 2, semantic memory in which the visual object 2 is associated with the knowledge of the user 1, visual impression on the visual object 2, and attractivity (saliency) indicating the degree of conspicuousness or the like of the visual object 2.

Next, the visual object 2 before the change is switched to the blank image 32, and the visual object 2 after the change is displayed after a predetermined period of time. In this case, the user 1 determines whether or not the visual object 2 after the change, which is currently displayed, is the same as the visual object 2 before the change, on the basis of the information such as a short term memory generated when the user recognizes the visual object 2 before the change.

Hence, the user 1 notices the change of the visual object 2 only when the user 1 can recognize a remarkable difference in the cognitive comparison with the visual impression or memories. This is a factor to cause the visual change blindness.

Use of the visual change blindness makes it possible to present various types of information in a manner that visual attention is not excessively attracted. Further, it is also possible to adjust the granularity of the information to be presented in accordance with the interest or the degree of understanding of the user 1.

Further, it is also possible to unconsciously correct (implicitly correct) the visual object 2 such as a photograph or a video call. This also makes it possible to change the visual information that has already been displayed so as not to be conscious, or to change an image of a face or the like to be presented to an online speaker so as not to be noticed by the other party.

Meanwhile, in order to implement such an unconscious change of the visual information, it is important to estimate how the user 1 recognizes the visual change before and after the change of the visual information in comparison (visual recognition comparison) of the visual information at the recognition level of the user 1. For example, even when the visual information is changed by using the change blindness, if the amount of change of the visual information is sufficiently large or the like, there is a high possibility that the user 1 will notice the change.

In this regard, in this embodiment, in order to suitably set the amount of change of the visual information (visual object 2), a distance concept in a visual cognitive space of a human, such as a visual impression or a higher-order visual context, is introduced instead of the information on the pixel value level constituting the visual information.

The visual cognitive space used herein is, for example, a space used when comparing targets visually recognized by a human. For example, in the cognitive space, as the distance between the targets to be compared becomes smaller, the targets are determined to be more similar. Conversely, as the distance between the targets becomes larger, the targets are determined to be less similar.

In the present disclosure, the distance in the visual cognitive space will be referred to as a cognitive distance.

The cognitive distance can be expressed, for example, as a degree to which a human can recognize a difference between the targets to be compared. In this embodiment, the latent cognitive scale in which the cognitive distance is defined using the distance in the latent space is used as a scale for quantitatively treating the cognitive distance (the degree of recognition of visual change).

Hereinafter, the characteristics of the latent space will be described.

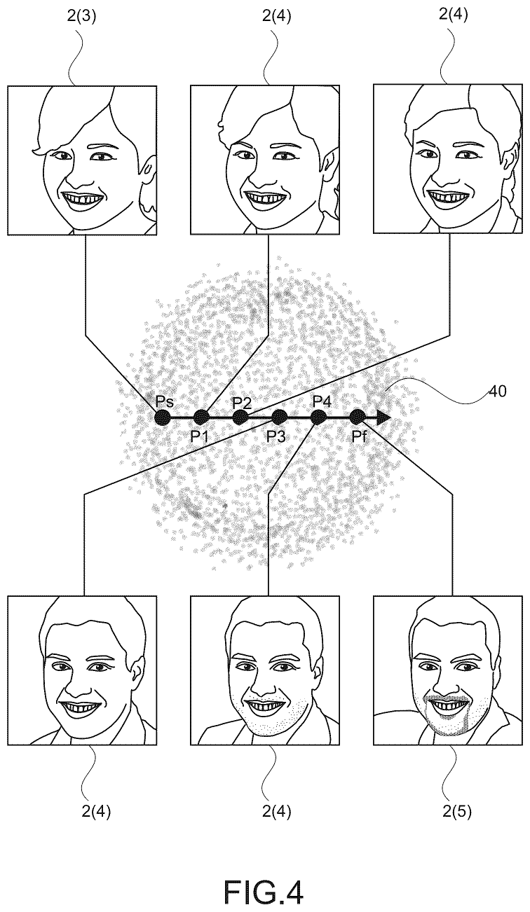

FIG. 4 is a schematic view showing an example of the latent space relating to the visual object.

A latent space 40 is a space representing the visual objects 2 by using the latent variables. FIG. 4 schematically illustrates the latent space 40 as a set of points each corresponding to the visual object 2.

The latent space 40 is typically configured by performing machine learning using a data set of a large number of visual objects 2. The data set used herein is, for example, a set of data of visual objects of the same motif (e.g., human image, animal image, plant image, landscape image, and food image).

For example, machine learning is used to extract latent variables for the respective visual objects 2 in the data set. The latent space 40 is configured on the basis of the latent variables thus extracted.

For example, it is possible to specify points in the latent space 40 by specifying values of a plurality of latent variables. A single visual object 2 is represented by a point in this latent space 40 (a set of values of the plurality of latent variables).

As the distance between two visual objects 2 becomes shorter in the latent space 40, the visual objects 2 become more similar to each other.

Further, for a visual object 2 not included in the data set, for example, the latent variable of the visual object 2 is extracted to calculate a point in the latent space 40 (a position in the latent space 40) This makes it possible to arrange a visual object 2, which is not in the data set, such as the input object 3 or the reference object 5 (see FIG. 1), in the latent space 40.

The input object 3 (or reference object 5) is arranged in the latent space 40, so that morphing processing of changing the input object 3 becomes possible. By this morphing processing, the data relating to at least one change object 4 is calculated.

In this embodiment, the object processing unit 27 shown in FIG. 2 executes morphing processing and calculates the data relating to the change object 4.

FIG. 4 illustrates four change objects 4 in which the input object 3 is changed to approach the reference object 5. In the following description, a point corresponding to the input object 3 will be referred to as Ps, a point corresponding to the reference object 5 will be referred to as Pf, and points corresponding to the four change objects 4 will be referred to as P1 to P4.

Here, the direction from the input object 3 (Ps) toward the reference object 5 (Pf) becomes a change direction 41 in which the input object 3 is changed.

Further, the points P1 to P4 are set in this order on the straight line between the points Ps and Pf. In other words, the change object 4 represented by the point P1 is the closest to the input object 3, and the change object 4 represented by the point P4 is the closest to the reference object 5.

Note that if the reference object 5 is not used, the change direction 41 is appropriately set on the basis of the information indicating the change direction 41 in the latent space 40. The data relating to at least one change object, which is obtained by changing the input object 3 along the change direction 41 in the latent space 40, is then output. This makes it possible to change the input object 3 in a desired direction.

Note that the change direction 41 may be a direction approaching the reference object 5 as described above, or may be a direction set by the user 1. Further, a default change direction 41 or the like may be set.

Further, as described with reference to FIG. 1, if the visual content 10 is displayed, the change objects 4 are switched for display in a predetermined order instead of the input object 3. This order is typically the order of a closer distance between the input object 3 and each change object 4 in the latent space 40. In other words, the change objects 4 are displayed in the order similar to the input object 3.

For example, in the example shown in FIG. 4, the change objects 4 represented by the points P1 to P4 are displayed in the stated order. This makes it possible to change the input object 3 to a target reference object 5 in a stepwise manner, for example.

As described above, in the object processing unit 27, the amount of change in the change direction 41 in the latent space 40 (the distance in the latent space) or the number of times of change is set, so that the data relating to the change object 4 is calculated. The amount of change or the number of times of change is set on the basis of the latent cognitive scale.

In the following description, a method of generating the latent cognitive scale will be specifically described.

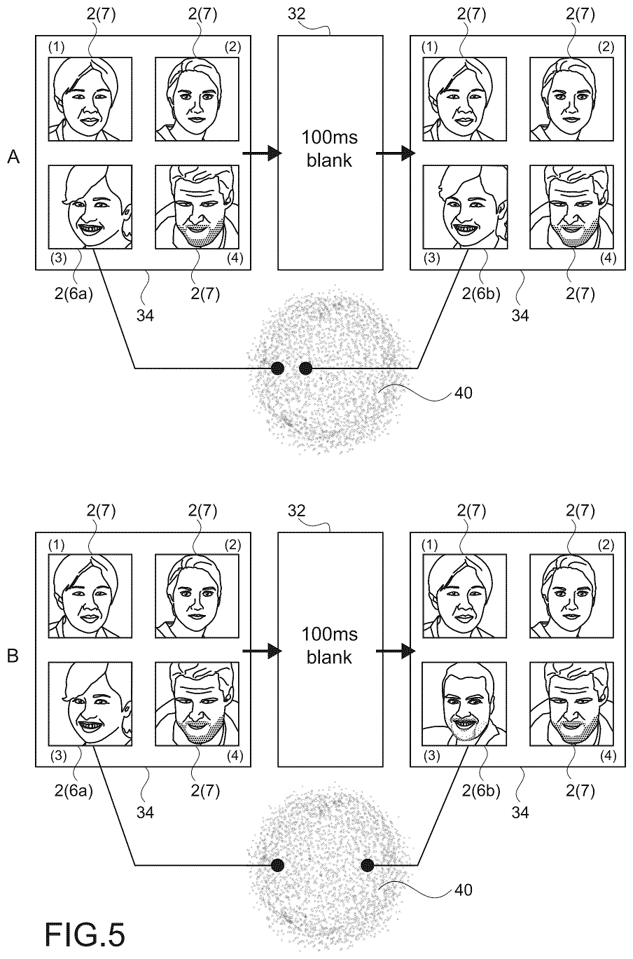

FIG. 5 is a schematic view for describing a method of generating the latent cognitive scale.

The latent cognitive scale is generated by performing a cognitive experiment that allows a human to determine whether or not the images of two visual objects 2 are the same at the cognitive level, and associating the determination result with the distance between the two visual objects 2 in the latent space. This cognitive experiment can be an experiment to examine a human cognitive distance between the two visual objects 2.

Specifically, the visual objects 2 represented by two different points in the latent space 40 are displayed to a human tester in such a manner that the visual change information 31 as shown in A of FIG. 3 does not occur. The cognitive detection rate of the tester with respect to the change of the visual objects 2 is then measured.

A and B of FIG. 5 illustrate examples of a test screen 34 used in the cognitive experiment. On the test screen 34, four visual objects 2 (visual objects 2 to which numbers of 1 to 4 are assigned) disposed in a 2×2 grid pattern are displayed.

Here, the images obtained by imaging the faces of persons are used as the visual objects 2. Therefore, the cognitive experiment shown in A and B of FIG. 5 is an experiment to generate a latent cognitive scale relating to the human face.

In the cognitive experiment, first, a test screen 34 before change (the test screen 34 on the left side in the figure) is displayed. Next, the entire test screen 34 before change is switched to a blank image 32. The blank image 32 is displayed for a predetermined period of time (e.g., 100 ms). Next, the blank image 32 is switched to a test screen 34 after change.

This is a display method for causing visual change blindness to the user 1 in response to a change on the test screen 34. This makes it possible to present the change in the images without generating the visual change information 31.

In the test screen 34, only one visual object 2 in the four visual objects 2 changes before and after the display of the blank image 32. Hereinafter, the visual object 2 that changes before and after the display of the blank image 32 will be referred to as a test object 6. Further, the test objects 6 before and after the change will be referred to as test objects 6a and 6b.

Note that the other three visual objects 2 are dummy objects 7 that do not change before and after the blank image 32.

In A and B of FIG. 5, the visual object 2 disposed on the lower left of the test screen 34 (the third visual object 2) is the test object 6.

In this embodiment, the test object 6a corresponds to a first visual object, and the test object 6b corresponds to a second visual object 2.

In the example shown in A of FIG. 5, the distance between the test objects 6a and 6b in the latent space 40 is relatively small. Therefore, the test objects 6a and 6b may be recognized as similar images. In this case, there is a possibility that the change of the test objects 6 is not detected.

In the example shown in B of FIG. 5, the distance between the test objects 6a and 6b in the latent space 40 is relatively large. Therefore, the test objects 6a and 6b may be recognized as different images. In this case, there is a high possibility that the change of the test objects 6 is detected.

In such a cognitive experiment, the tester selects the number assigned to the visual object 2 (test object 6) that seems to have changed in the test screen 34. This determination operation is performed while the amount of change for changing the test object 6 (the distance between the test objects 6a and 6b in the latent space 40) and the change direction 41 are changed to various values.

Therefore, such a cognitive experiment can be a test for allowing the tester to determine the presence or absence of a cognitive difference between the test objects 6a and 6b.

Such a cognitive experiment is performed on a plurality of testers. As a result, a human cognitive detection rate (correct answer rate in the determination operation) based on a visual change corresponding to the distance in the change direction 41 is calculated for each change direction 41 in the latent space 40.

In the following description, the cognitive detection rate with respect to the visual change of the test object 6 will be simply referred to as a change detection rate. The change detection rate represents the degree of recognition with respect to a visual change, and corresponds to a distance (cognitive distance) in a visual cognitive space. For example, if the change detection rate is high, the cognitive distance is large, and if the change detection rate is low, the cognitive distance is small.

In this embodiment, the correspondence between the change detection rate thus calculated and the distance between the test objects 6a and 6b in the latent space 40 is modeled to generate the latent cognitive scale. Note that, for example, an approximate curve for approximating experimental data, a numerical interpolation for interpolating experimental data, or the like may be appropriately used for modeling.

The method of generating a latent cognitive scale 45 is not limited to the method described with reference to FIG. 5, and various methods may be used.

For example, the following cognitive experiment may be performed: at the same time as the test object 6a, the test object 6b and a test object 6c are displayed to allow the tester to determine which object is close to the test object 6a. This can be an experiment to directly determine the degree of cognitive difference.

The test objects 6b and 6c are, for example, objects obtained by changing the test object 6a in the same change direction 41 with different amounts of change. Among them, the test object 6b is set to an object closer to the test object 6a than the test object 6c. In other words, the test object 6b is an answer object, and the test object 6c is a comparative object.

If the correct answer rate of this cognitive experiment is high, it is assumed that the distance (the amount of change) between the test objects 6a and 6b in the latent space 40 can be properly recognized, and the degree of recognition (cognitive distance) with respect to that distance is set to be large. Conversely, if the correct answer rate is low, the degree of recognition with respect to the distance between the test objects 6a and 6b is set to be small. Therefore, such a cognitive experiment can be a test for allowing the tester to determine the degree of cognitive difference between the test objects 6a and 6b.

As described above, the method of generating the latent cognitive scale 45 includes the following procedure.

First, data relating to each of the test object 6a and the test object 6b represented by different points in the latent space 40 relating to the visual objects 2 are generated.

Next, a cognitive experiment for allowing the tester to determine the presence or absence of a cognitive difference between the test objects 6a and 6b is performed. Alternatively, a cognitive experiment for allowing the tester to determine the degree of cognitive difference between the test objects 6a and 6b is performed.

Next, the data obtained by associating the determination result of the cognitive experiment with the distance between the points representing the test objects 6a and 6b in the latent space 40 is acquired.

Subsequently, on the basis of the acquired data, a latent cognitive scale 45 representing a relationship between the distance in the latent space 40 and the degree of recognition with respect to the change of the visual object 2 based on that distance is generated.

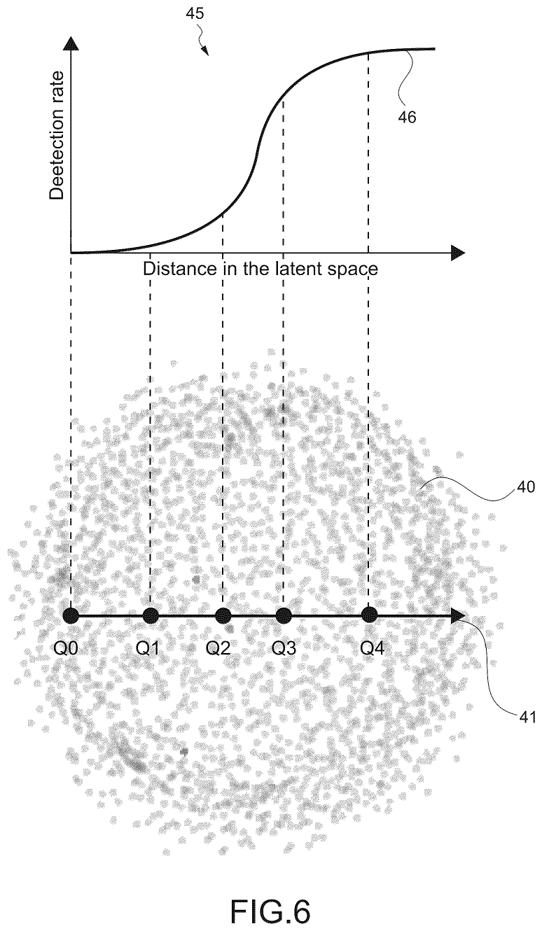

FIG. 6 is a schematic view showing an example of a graph constituting the latent cognitive scale. FIG. 6 illustrates a schematic graph constituting the latent cognitive scale 45. The horizontal axis of the graph is a distance in the latent space 40 (Distance in the Latent Space), and the vertical axis thereof is a change detection rate (Detection Rate) with respect to the visual change of the test object 6.

In the following description, the graph of the distance in the latent space 40 and the change detection rate will be described as a scale graph 46. The scale graph 46 is graph data showing the degree of recognition with respect to the change of the visual object 2 based on the distance in the latent space 40. The data format of the scale graph 46 is not limited. The scale graph 46 may be recorded, for example, as a set of data points constituting the graph. Further, for example, when the shape of the graph is represented by a model such as an approximate curve, a combination of variables of the model is recorded as the scale graph 46. Alternatively, both the data points and the combination of variables may be recorded.

The scale graph 46 shown in FIG. 6 is a plot of the change detection rate with respect to one change direction 41 starting from a point P0 in the latent space 40.

A point Q0 as a starting point of the scale graph 46 is, for example, a point corresponding to the test object 6a before change shown in FIG. 5. For example, at a point (e.g., Q1) having a relatively short distance from the point Q0, the change detection rate is small because the amount of change is small. Conversely, at a point where the distance from the point Q0 is sufficiently large (e.g., Q4), since the amount of change is also sufficiently large, the change detection rate is high.

Further, in the scale graph 46, there is a section in which the change detection rate rapidly increases (e.g., a section between the points Q2 and Q3). In this section, for example, it is considered that the cognitive difference with respect to the visual object 2 corresponding to the point Q0 increases. In such a manner, it is conceivable that the change detection rate changes nonlinearly with respect to the distance in the latent space 40.

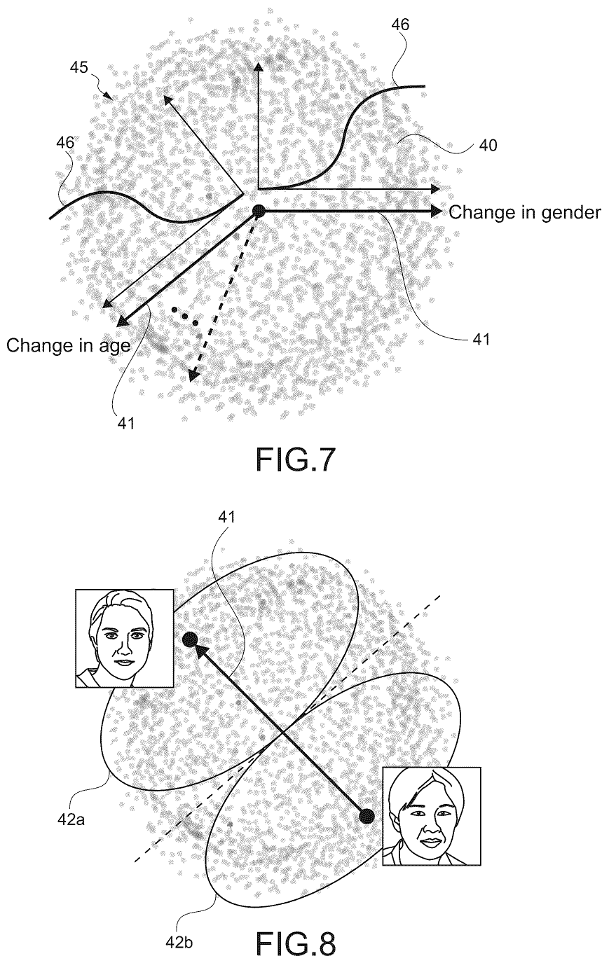

FIG. 7 is a schematic view showing examples of the scale graphs with different change directions 41.

As described above, when the latent cognitive scale 45 is generated, a plurality of change directions 41 is set, and the scale graphs 46 relating to the respective change directions 41 are calculated.

Therefore, the latent cognitive scale 45 includes a plurality of pieces of graph data (scale graphs 46) each indicating the degree of recognition with respect to the change of the visual object 2 based on the distance in the latent space 40 in each of the change directions 41 mutually different in the latent space 40.

FIG. 7 schematically illustrates the change directions 41 in the latent space 40 and the scale graphs 46 corresponding to the respective change directions 41.

For example, it is assumed that the same visual object 2 is changed along the different change directions 41. In this case, the change state of the change object 4 differs depending on the change direction 41. For example, as shown in FIG. 7, there are a change direction 41 in which the age changes, a change direction 41 in which the gender changes, and the like in the latent space 40 constituted by human images.

FIG. 8 is a schematic view showing an example of the change direction 41 in the latent space 40. FIG. 8 schematically illustrates a region 42a including a face of a man and a region 42b including a face of a woman in the latent space 40. For example, if the visual object 2 is changed beyond the boundary (dotted line in the figure) between the region 42a and the region 42b, the image of the man is changed to the image of the woman, and conversely, the image of the woman is changed to the image of the man.

In such a manner, the change direction 41 in which the visual object 2 is changed beyond the boundary between the region 42a and the region 42b is a direction in which the gender of a person is changed.

In addition to the above, for example, various change directions 41 having different semantic characteristics, such as a change direction 41 in which the age increases (decreases), a change direction 41 in which the degree of opening of the eyes changes, a change direction 41 in which the length and color of the hair change, or a change direction 41 in which the above-mentioned changes are combined, can be set in the latent space 40.

As described above, the change direction 41 can be an axis for changing various higher-order semantic characteristics of the visual information. Depending on such semantic characteristics, the characteristics of the latent cognitive scale 45 vary. In other words, the shape of the scale graph 46 is different for each change direction 41.

As the latent space 40 used for generating the latent cognitive scale 45, it is possible to use a feature amount space constituted by at least one feature amount relating to the visual object 2.

The feature amount space is, for example, a high-dimensional vector space in which various feature amounts are set as latent variables. In other words, the feature amount space can be said to be the latent space 40 in which the semantic characteristics of the latent variables are clearly shown. Note that the feature amount space may be configured using only a single feature amount. This results in one-dimensional data in which the visual objects 2 are arranged along one feature.

For example, in a case where an input object input as a processing target is an image obtained by imaging a person, the change direction 41 is set as a direction along a feature amount indicating an appearance feature of the person. Examples of the feature amount indicating the appearance feature of the person include the feature amounts indicating gender, age, the degree of opening of eyes, the length of a hair, and the like.

In such a manner, when the feature amount space is used, it is possible to easily set an easy-to-understand change direction 41 by selecting a necessary feature amount.

Further, the latent cognitive scale 45 is configured to have characteristics suitable for an assumed user 1.

For example, it is conceivable that the cognitive distance (change detection rate) varies depending on the characteristics of the user 1, such as the gender and the age. For this reason, it is possible to configure the latent cognitive scale 45 (scale graph 46) according to the profile of the user by, for example, performing a cognitive experiment for male (or female) testers, a cognitive experiment for testers classified by age groups, and the like.

As described above, the plurality of scale graphs 46 constituting the latent cognitive scale 45 may include data generated for each human characteristic. In this case, data matched with the characteristics of the user 1 is selected from the plurality of scale graphs 46 and used. This makes it possible to appropriately generate the visual content 10 suitable for the assumed user 1.

As described above, the latent cognitive scale 45 is a model in which the distance in the latent space 40 can be used as the human cognitive distance (change detection rate) by associating the latent space 40 with the human change cognitive characteristics. Use of the latent cognitive scale 45 makes it possible to calculate a design guideline showing how much change should be set when the visual object 2 is changed in an unconscious manner.

Use of the latent cognitive scale 45 (scale graph 46) makes it possible to constitute a distance calculation function that outputs the cognitive distance of each visual object 2 with the two visual objects 2 as inputs.

In the distance calculation function, for example, a change direction 41 connecting two visual objects 2 is calculated. A scale graph 46 corresponding to the change direction 41 is then selected, and a position of each visual object 2 on the selected scale graph 46 is calculated. The difference in the change detection rates at the positions of the respective visual objects 2 is output as the cognitive distance between the visual objects 2.

In this embodiment, such a distance calculation function is implemented in the object processing unit 27 described with reference to FIG. 2.

As an application example of the distance calculation function, there is a tool for setting the amount of change when changing the visual object 2. In this tool, for example, the amount of change of the visual object 2 is set to a small value in a section in which the cognitive distance (change detection rate) changes steeply. This makes it possible to prevent the recognition of the visual change.

Further, a tool or the like that divides the change of the visual object 2 a plurality of times may be implemented in accordance with the linear and non-linear characteristics of the scale graph 46. In this case, it is possible to probabilistically estimate the risk of change detection due to a plurality of times of division of the change.

Hereinafter, processing using the latent cognitive scale 45 will be described in detail.

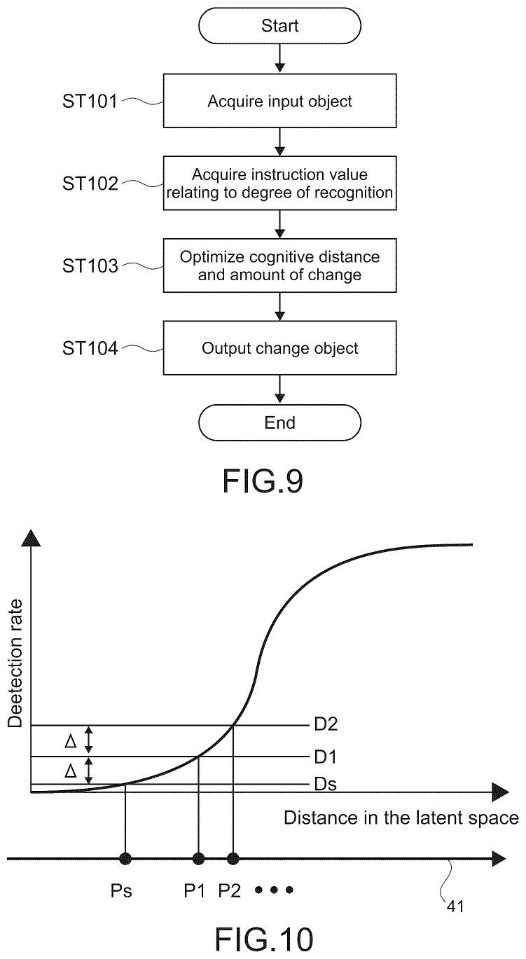

FIG. 9 is a flowchart showing an example of the change object output processing. FIG. 10 is a schematic view for describing the change object output processing.

In this embodiment, the change object output processing of outputting data relating to at least one change object 4, in which the input object 3 is changed, is executed on the basis of the latent cognitive scale 45.

In this processing, first, the data acquisition unit 26 acquires an input object 3 (Step 101). For example, data of a visual object 2 to be the input object 3 is appropriately read from the storage unit 24, other devices, and the like.

Next, the data acquisition unit 26 reads an instruction value relating to the degree of recognition with respect to a change of the visual object 2 (Step 102). For example, the instruction value input by the user 1 or the instruction value stored in the storage unit 24 is appropriately read.

In this embodiment, the indication value of the degree of recognition is a threshold A of the degree of recognition. The threshold A is represented as a threshold of the change detection rate with respect to the visual change caused by, for example, switching the change object 4 for display.

Further, in Step 102, information indicating a change direction 41 for changing the visual object 2 is read.

Next, the object processing unit 27 executes a calculation for optimizing the cognitive distance and the amount of change (optimization calculation) (Step 103). Here, the amount of change is the amount of change in the visual change caused by switching the change object 4 for display. This is the amount of change between each change object 4 and the object displayed immediately before each change object 4 (the input object 3 or the change object 4 displayed immediately before each change object 4).

Hereinafter, the optimization calculation will be described with reference to FIG. 10. In the optimization calculation, first, the position (Ps) of the input object 3 in the latent space 40 is calculated. Further, a scale graph 46 corresponding to a change direction 41 of the input object 3 is selected.

The amount of change to be set for each change object 4 is then set in accordance with the threshold A of the degree of recognition (change detection rate) on the basis of the selected scale graph 46.

For example, in the scale graph 46, a change detection rate at a position Ps of the input object 3 is Ds. In this case, a position P1 of a change object 4 to be displayed next to the input object 3 is set within the range of the change detection rate smaller than the value (Ds+Δ) obtained by adding Δ to the change detection rate Ds of the input object 3. This will set a distance (P1-Ps) that is the amount of change of the change object 4 at P1.

Further, a position P2 of a change object 4 to be displayed next to the change object 4 at P1 is set. In this case, the position P2 is set within the range of the change detection rate smaller than the value (D1+Δ) obtained by adding Δ to the change detection rate D1 at the position P1.

The points subsequent to P2 are also calculated in the same manner.

As described above, in this embodiment, the distance in the latent space 40 corresponding to the amount of change of the visual change caused by switching the change object 4 for display is set such that the degree of recognition with respect to the visual change caused by switching the change object 4 for display does not exceed the threshold A of the degree of recognition.

This makes it possible to suppress the risk, in which the user 1 detects a visual change caused each time the change object 4 is switched, to a threshold value or less.

Further, in this embodiment, the distance in the latent space 40 corresponding to the amount of change is set to the maximum value within a range in which the degree of recognition with respect to the visual change caused by switching the change object 4 for display does not exceed the threshold A of the degree of recognition.

In other words, the position P1 of the change object 4 to be displayed next to the input object 3 is set to a position where D1=Ds+Δ. Further, the position P2 of the change object 4 to be displayed next is set to a position where D2=D1+Δ.

This makes it possible to greatly change the change object 4 while suppressing the detection risk of the visual change of the change object 4. As a result, the necessary number of times of change can be reduced, and the detection risk can be sufficiently reduced.

Referring back to FIG. 9, the data relating to the change object 4 is output using the processing result of the optimization processing (Step 104). For example, the data relating to the change objects 4 corresponding to the respective points are output from the latent variables at the positions P1, P2, . . . of the change objects 4.

For example, if the number of times in which the input object 3 is changed is set, the data relating to the change object 4 corresponding to the number of times is calculated.

Further, if the reference object 5 to be a final change target is set, data relating to at least one change object 4, in which the input object 3 is changed to approach the reference object 5 corresponding to the input object 3 in the latent space 40, is output (see FIG. 4 and the like).

This makes it possible to switch the input object 3 to the reference object 5 for display without being noticed by the user 1.

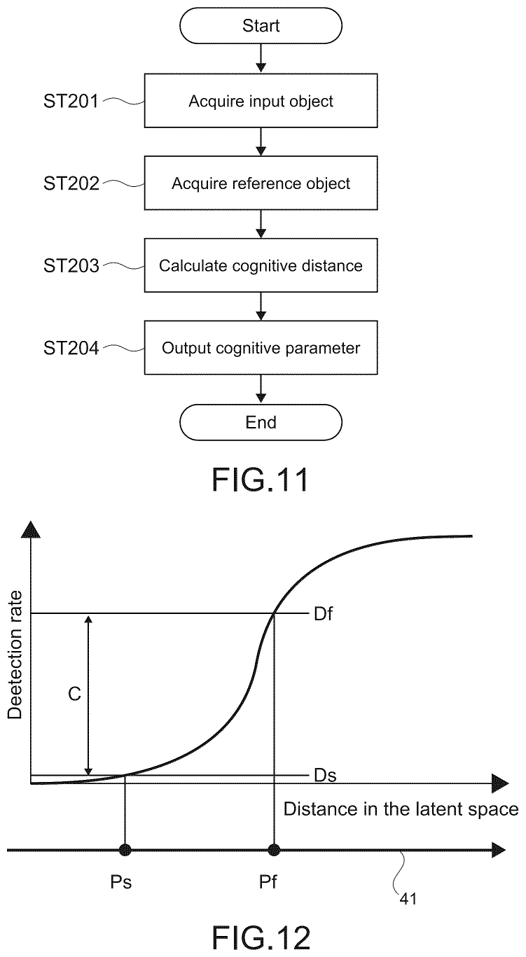

FIG. 11 is a flowchart showing an example of the cognitive parameter output processing. FIG. 12 is a schematic view for describing the cognitive parameter output processing.

In this embodiment, the cognitive parameter output processing of outputting a cognitive parameter C representing the degree of recognition with respect to the change from the input object 3 to the reference object 5 is executed on the basis of the latent cognitive scale 45.

As the cognitive parameter C, typically, a change detection rate with respect to an overall visual change caused by changing the input object 3 to the reference object 5 is output.

Here, the change detection rate with respect to the overall visual change is a change detection rate with respect to the visual change caused before the reference object 5 is displayed in the process of changing the input object 3 to the reference object 5.

For example, the overall change detection rate differs between a case where the input object 3 directly changes to the reference object 5 and a case where the input object 3 changes to the reference object 5 stepwise via the change object 4. The overall change detection rate in the change process as described above is output as the cognitive parameter C.

Hereinafter, description will be given on a method of calculating the cognitive parameter C, in which the change processing of changing the input object 3 to the reference object 5 at one time (hereinafter, referred to as first change processing) is assumed.

In the cognitive parameter output processing, first, the data acquisition unit 26 acquires the input object 3 and the reference object 5 (Steps 201 and 202) For example, the data of the visual objects 2 to be the input object 3 and the reference object 5 is appropriately read from the storage unit 24, other devices, and the like.

Next, the object processing unit 27 executes processing of calculating a cognitive distance between the input object 3 and the reference object 5 (cognitive distance calculation) (Step 203).

Hereinafter, the cognitive distance calculation will be described with reference to FIG. 12. In the cognitive distance calculation, a position (Ps) of the input object 3 and a position (Pf) of the reference object 5 in the latent space 40 are calculated first. Further, a change direction 41 of the input object 3, that is, a scale graph 46 corresponding to the direction from Ps toward Pf, is selected.

The cognitive distance between the input object 3 and the reference object 5 is then calculated on the basis of the selected scale graph 46.

In the example shown in FIG. 12, the difference between the change detection rates Ds and Df of the input object 3 and the reference object 5 in the scale graph 46 is calculated as the cognitive distance. In other words, a difference (Df-Ds) between the change detection rate Df of the reference object 5 and the change detection rate Ds of the input object 3 is calculated. This is a change detection rate when the input object 3 is directly changed to the reference object 5, and corresponds to the cognitive distance between the input object 3 and the reference object 5.

Referring back to FIG. 11, the cognitive parameter C relating to the degree of recognition is output using the processing result of the cognitive distance calculation (Step 204). Here, as the cognitive parameter C, a first change detection rate in the first change processing in which the input object 3 is directly changed to the reference object 5 is output. In this case, the difference (Df-Ds) between the change detection rates of the input object 3 and the reference object 5 is used as the first change detection rate as it is. Therefore, the cognitive parameter C is as follows: C=Df−Ds.

As described above, the object processing unit 27 outputs the first change detection rate with respect to the visual change associated with the first change processing of changing the input object 3 to the reference object 5 at one time. This makes it possible to estimate a rate at which the user 1 notices the change when the input object 3 is directly changed to the reference object 5.

Further, the first change detection rate output as the cognitive parameter C can also be used as a parameter representing the cognitive distance between the input object 3 and the reference object 5.

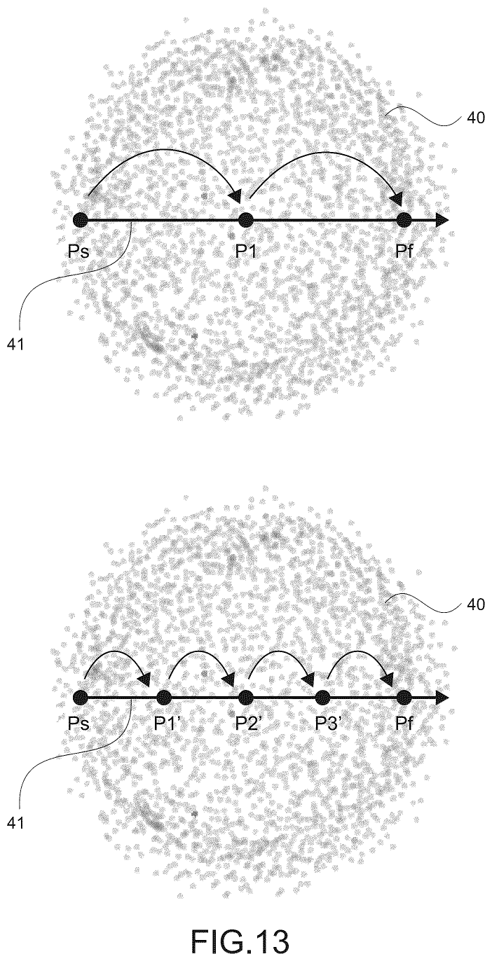

FIG. 13 is a schematic view showing another example of the cognitive parameter output processing. Here, description will be given on a method of calculating the cognitive parameter C, in which the change processing of changing the input object 3 to the reference object 5 a plurality of times (hereinafter, referred to as second change processing) is assumed.

The second change processing includes a plurality of division change processes in which the input object 3 is changed to the reference object 5 a plurality of times. For example, in A of FIG. 13, the input object 3 is changed to the reference object 5 by two times of division change processes through a change object 4 corresponding to a point P1. Further, in B of FIG. 13, the input object 3 is changed to the reference object 5 by four times of division change processes through three change objects 4 corresponding to points P1′ to P3′.

In the case where the second change processing is assumed as described above, in the cognitive parameter output processing, a second change detection rate with respect to the visual change associated with the second change processing is output as the cognitive parameter C. Therefore, the second change detection rate is a rate at which a visual change is detected before the plurality of division change processes is completed to finally display the reference object 5.

The second change detection rate can be represented as a product of the division change detection rates, which are the change detection rates in the plurality of division change processes. Therefore, when the second change detection rate is output, first, the division change detection rate for each division change process is calculated.

Specifically, in each division change process, a difference between the value of the scale graph 46 at the position of the object after the change and the value of the scale graph 46 at the position of the object before the change is calculated. The difference between the values of the scale graphs before and after the change is the division change detection rate for each division change process. The division change detection rate is

Next, the second change detection rate is calculated by integrating the division change detection rates for the division change processes. As described above, in this embodiment, the second change detection rate is calculated by multiplying the division change detection rates with respect to the visual change associated with the plurality of division change processes.

For example, in the example shown in A of FIG. 13, the product of the first division change detection rate and the second division change detection rate is the total change detection rate (second change detection rate). Similarly, in the example shown in B of FIG. 13, the product of the first to fourth division change detection rates is the second change detection rate.

The second change detection rate thus calculated is used as the cognitive parameter C. As a result, when the input object 3 is changed stepwise, it is possible to estimate a rate (concealment success rate) or the like at which the change to the reference object 5 succeeds without being noticed by the user 1. Note that the concealment success rate may be directly calculated as the cognitive parameter C. In this case, the concealment success rate is configured, for example, as a function inversely proportional to the change detection rate.

As described above, in the second change processing, since the input object 3 changes through the change objects 4, the rate at which the visual change of one time is noticed is reduced as compared to the first change processing, for example. Meanwhile, since the number of times of visual change occurrence increases, the visual change may be noticed if the number of times of change is extremely large, for example.

In this regard, in this embodiment, for the second change processing in which the number of times of change and the amount of change are set to different values, the overall detection rate in each processing (second change detection rate) is output. The output results are then compared, so that the second change processing in which the visual change can be sufficiently concealed as a whole (e.g., the second change detection rate is equal to or less than the threshold) is designed (see FIG. 13).

[Application Example: Authoring Tool]

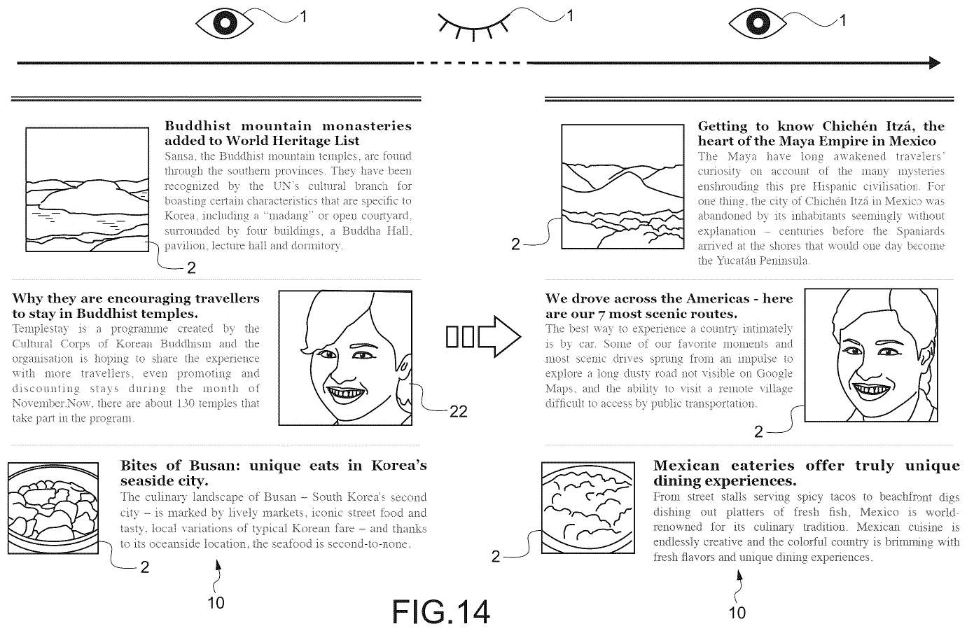

FIG. 14 is a schematic view showing an example of content generated using an authoring tool to which the content generation system 100 is applied. The authoring tool is an application for designing and editing the visual content 10 including the visual object 2 such as an image.

The visual content 10 shown in FIG. 14 is generated using an authoring tool to which the content generation system 100 is applied, and is designed such that the display contents change without being noticed by the user 1. Here, an article including photographs and letters will be described as an example of the visual content 10.

The diagram on the left side of FIG. 14 is visual content 10 before the display contents are changed. Further, the diagram on the right side of FIG. 14 is visual content 10 after the display contents are completely changed. The contents (photographs and text) of the article are completely different between the visual content 10 before the change and the visual content 10 after the change.

In the visual content 10, the second change processing in which the contents of each article are changed stepwise is executed at a timing at which visual change blindness occurs with respect to the user 1. Specifically, a state in which the user 1 closes the eyes is detected, and the contents of each article are switched stepwise at that timing.

Note that the number of times in which each visual object 2 included in the article is changed is set individually. Therefore, for example, an image of a landscape, an image of a person, and an image of a dish, which are the visual objects 2 in the article, are switched by the number of times of change set for each image, and are updated to the images of different landscape, person, and dish, respectively.

The number of times of change and the amount of change of each visual object 2 are set on a design screen of the authoring tool.

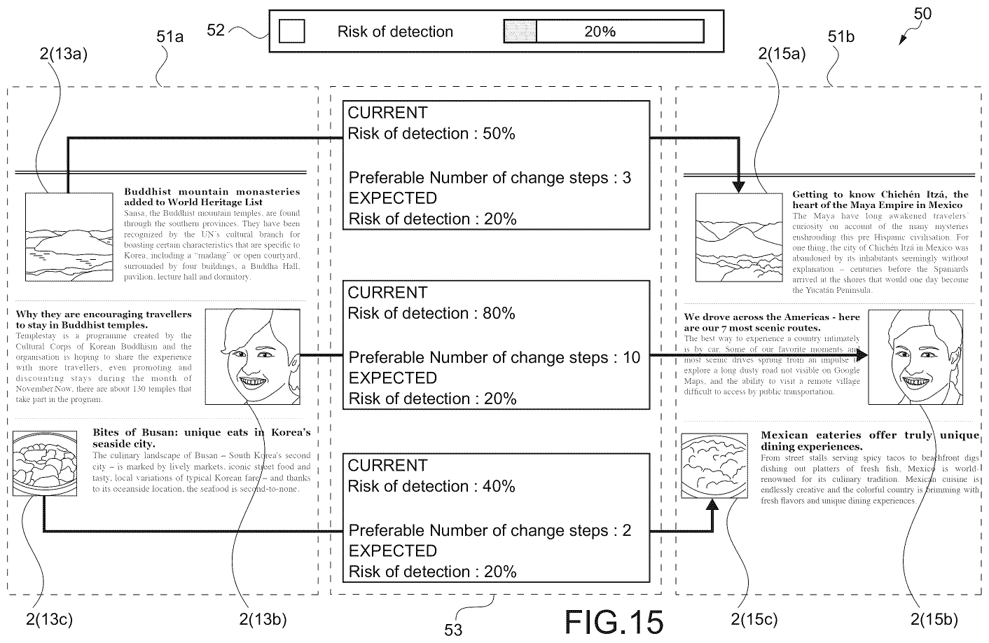

FIG. 15 is a schematic view showing an example of the design screen of the authoring tool. FIG. 15 illustrates a design screen 50 used in designing the visual content 10 shown in FIG. 14. The design screen 50 includes content input regions 51a and 51b, a threshold setting field 52, and an analysis result display region 53.

The content input regions 51a and 51b are regions for inputting the visual content 10 before and after the change. The visual content 10 before and after the change input by the user 1 is displayed in the content input regions 51a and 51b.

For example, each visual object 2 included in the visual content 10 input to the content input region 51a is an input object 3. Further, a visual object 2 included in the visual content 10 input to the content input region 51b is a reference object 5 corresponding to each input object 3.

As described above, in the example shown in FIG. 15, the reference object 5 is the object input by the user 1.

Hereinafter, an image of a landscape, an image of a person, and an image of a dish, which are included in the visual content 10 before the change, will be referred to as an input image 13a, an input image 13b, and an input image 13c, respectively. The input images 13a to 13c are input objects 3. Further, an image of a landscape, an image of a person, and an image of a dish, which are included in the visual content 10 after the change, will be referred to as a reference image 15a, a reference image 15b, and a reference image 15c, respectively. The reference images 15a to 15c are reference objects 5.

The threshold setting field 52 is a field for inputting a threshold for the second change processing of changing the visual content 10 a plurality of times. Here, a threshold of a second change detection rate with respect to a visual change associated with the second change processing is set. This threshold is a threshold of a change detection rate before the reference object 5 is finally displayed when each input object 3 is changed stepwise to the reference object 5 corresponding to each input object.

In the example shown in FIG. 15, an indicator for setting a threshold is displayed as the threshold setting field 52. In addition, a threshold setting field 52 for directly inputting a numerical value of the threshold may be provided.

The analysis result display region 53 is a region where the analysis result of each visual object 2 by the authoring tool is displayed. Here, the analysis results relating to the images of landscapes (input image 13a and reference image 15a), the images of persons (input image 13b and reference image 15b), and the images of dishes (input image 13c and reference image 15c), which are included in the visual content 10 before and after the change, are respectively displayed. This makes it possible for the user 1 to design the visual content 10 while confirming the analysis results.

The analysis results include a first change detection rate associated with the first change processing of changing the input object 3 to the reference object 5 at one time. This is a change detection rate when the input object 3 is directly changed to the reference object 5, and is calculated by, for example, the method described with reference to FIG. 12 and the like. In the setting screen 60, the first change detection rate is displayed as the current change detection rate (Current Risk of Detection).

Further, the analysis results include the number of times of processing (the number of times of change) of the second change processing of changing the input object 3 to the reference object 5 a plurality of times. As will be described later, in the authoring tool, optimization processing relating to the second change processing is executed. The optimal number of times of processing is calculated by the optimization processing. In the setting screen 60, the number of times of processing is displayed as the optimal number of change steps (Preferable Number of change steps).

Further, the analysis results include a second change detection rate with respect to a visual change associated with the second change processing. This is a change detection rate when the input object 3 is changed to the reference object 5 a plurality of times by the optimized second change processing. The second change detection rate is calculated by, for example, the method described with reference to FIG. 13 and the like. In the setting screen 60, the second change detection rate is displayed as an expected change detection rate (Expected Risk of Detection).

In addition to the above, the analysis results include the amount of change calculated by the optimization processing relating to the second change processing. This is the amount of change of each of a plurality of division change processes executed as the second change processing, and is a distance in a latent space for calculating the data relating to the change object 4. The information on the amount of change is not presented on the setting screen 60, but is used when the data relating to the change object 4 is calculated.

Hereinafter, the optimization processing relating to the second change processing will be described.

In the optimization processing, the data acquisition unit 26 acquires the threshold of the second change detection rate input to the threshold setting field 52. The object processing unit 27 then sets the number of times of the plurality of division change processes and the amount of change of each of the plurality of division change processes such that the second change detection rate is equal to or less than the threshold of the second change detection rate.

For example, in the optimization processing, first, the number of times of change of the second change processing is set to 1. Under the condition that the number of times of change is 1, the amount of change of the second change processing, that is, division processing, in which the second change detection rate is the lowest, is calculated on the basis of the latent cognitive scale 45.

Next, it is determined whether or not the second change detection rate is equal to or less than the threshold when the number of times of change is 1. If it is determined that the second change detection rate is equal to or less than the threshold, the optimized second change processing when the number of times of change is 1 is employed.

On the other hand, if it is determined that the second change detection rate is larger than the threshold, the number of times of change is set to 2, and under the condition that the number of times of change is 2, the second change processing in which the second change detection rate is the lowest is calculated. The second change detection rate at that time is determined as a threshold.

Such processing is repeated until the second change detection rate is equal to or less than the threshold.

This makes it possible to calculate the processing in which the change detection rate in the entire second change processing is equal to or less than the threshold while minimizing the number of times of change. As a result, it is possible to provide the visual content 10 that changes with a small number of times of change without being noticed by the user 1.

When the user 1 confirms each analysis result and determines that the number of times of change or the like is appropriate, the data relating to the change object 4 is calculated using the amount of change and the number of times of change calculated in the optimization processing. The calculated data relating to the change object 4 is stored, for example, as data of the visual content 10, and is used in displaying the visual content 10.

[Application Example: Video Communication Tool]

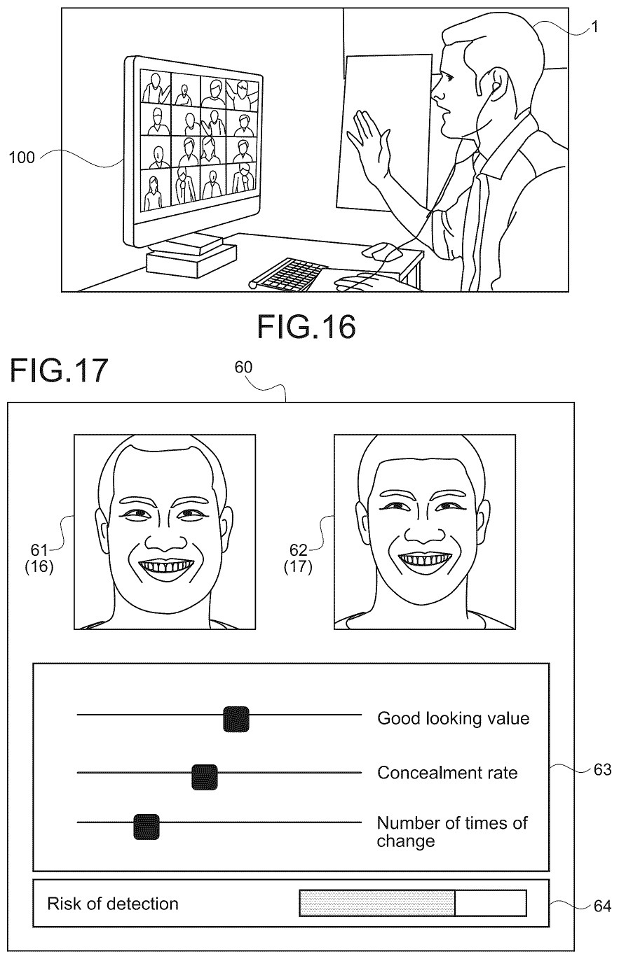

FIG. 16 is a schematic view showing an example of use of a video communication tool to which the content generation system 100 is applied. The video communication tool is, for example, a communication tool used in an online meeting or the like. For example, use of the video communication tool makes it possible for the user 1 to transmit a video of the user 1 to another user (communication partner) at a remote location.

In the video communication tool, the video obtained by imaging the user 1 is corrected, and the corrected video is transmitted to the communication partner. In such a tool, for example, appearance characteristics such as a facial color, age, hairstyle, and makeup are corrected. Of course, the contents of the correction are not limited and can be appropriately set.

Further, the timing at which the corrected video is switched is, for example, a timing at which visual change blindness or the like occurs in a communication partner who views the corrected video.

Additionally, the video communication tool has a guide function when setting such an appearance correction. Use of the guide function makes it possible for the user 1 to obtain a guideline when correction is added to his/her face information (video) in the online communication. Specifically, a cognitive parameter that serves as a guideline for changing the video in a manner that the change due to the correction is not recognized by the communication partner is presented.

FIG. 17 is a schematic view showing an example of a setting screen relating to the correction of face information. FIG. 17 illustrates an example of a setting screen 60 for correcting a video of the face of the user 1 (face information). Here, the processing of correcting the face information is performed.

The setting screen 60 includes an original image display region 61, a corrected image display region 62, a parameter setting field 63, and a detection risk display region 64.

The original image display region 61 is, for example, a region in which an original image 16 captured from the video obtained by imaging the user 1 is displayed. The original image 16 is an image not corrected, and is an image representing the current state of the user 1.

Here, the original image 16 obtained by imaging the face of the user 1 is an input object 3.

The corrected image display region 62 is a region in which a corrected image 17 obtained by correcting the original image 16 is displayed. The corrected image 17 is an image obtained by correcting the original image 16 on the basis of the change direction and the amount of change, which are set as correction parameters to be described later. The corrected image 17 is calculated by morphing processing of changing the original image 16 in the latent space 40.

Here, the corrected image 17 obtained by correcting the face of the user 1 is a reference object 5 corresponding to the original image 16 that is the input object 3. As described above, in the video communication tool, the reference object 5 is an object obtained by changing the input object in accordance with the change direction and the amount of change, which have been input by the user 1.

The parameter setting field 63 is a field for setting various parameters relating to the correction of the original image 16. In the parameter setting field 63, a correction parameter (Good looking value), a concealment rate, and the number of times of change are set.

The user 1 can set each parameter by moving sliders provided in the parameter setting field 63.

The correction parameter is a parameter for specifying the change direction 41 (correction direction) for changing the original image 16 and the amount of change (amount of correction). The change direction 41 for changing the original image 16 is, for example, set to a direction in which the contour of the face becomes thinner or the age becomes younger in the latent space 40. Further, the value indicated by the slider is the amount of change of the original image 16.

For example, if the feature amount space is set as the latent space 40, an axis corresponding to the feature amount corresponding to the contour of the face or the feature amount corresponding to the age is specified as the change direction 41. Further, the change direction 41 may be set by combining a plurality of feature amounts.

In this case, the instruction information relating to the change direction 41 is information indicating the change direction 41 by at least one of the feature amounts. Use of the feature amount makes it possible to easily set the change direction 41.

The concealment rate is a parameter indicating the degree of concealment of a change that occurs when the image is switched in the correction of the original image 16. In other words, it can be said that the concealment rate represents the degree to which the visual change associated with the switching of the image is not noticed.

For example, as the visual change becomes larger, the concealment rate becomes smaller, and as the visual change becomes smaller, the concealment rate becomes larger. This is a relationship opposite to the change detection rate.

The number of times of change is the number of times of display switching performed before the original image 16 is corrected to be the corrected image 17. For example, when the number of times of change is one, the first change processing of changing the original image 16 to the corrected image 17 at one time is executed. Further, when the number of times of change is multiple, the second change processing of changing the original image 16 to the corrected image 17 a plurality of times is executed.

The detection risk display region 64 is a region for displaying a detection risk in which the correction is detected when the original image 16 is changed to the corrected image 17 by using the values set in the parameter setting field 63. The detection risk is represented by, for example, an overall change detection rate before the corrected image 17 as the reference object 5 is displayed.

In the video communication tool, the object processing unit 27 calculates the detection risk.

For example, when the number of times of change is set to 1, the correction processing is the first change processing. In this case, the first change detection rate is calculated as the detection risk (see FIG. 12 and the like).

Further, for example, when the number of times of change is set to be multiple, the correction processing is the second change processing of changing stepwise through change objects. In this case, the second change processing corresponding to the concealment rate and the number of times of change is appropriately set, and the second change detection rate is calculated as the detection risk (see FIG. 13 and the like).

The calculated detection risk is displayed in the detection risk display region 64.

As described above, displaying the detection risk makes it possible to notify the user 1 of information indicating whether or not the set correction contents are easily noticed by the communication partner. Further, the user can set a correction with a lower detection risk by measures such as reducing the amount of change or increasing the number of times of change.

When the user 1 confirms and acknowledges the detection risk, the correction processing of correcting the video, which is obtained by imaging the user 1, with the contents set in the parameter setting field 63 is executed, and the video corrected in a stepwise manner is appropriately transmitted to the communication partner.

As described above, in the controller 25 according to this embodiment, the data relating to the change object 4 or the cognitive parameter is output using the latent cognitive scale 45 in which the degree of recognition with respect to the change of the visual object 2 is associated with the distance in the latent space 40. The change object 4 is an object in which the input object 3 is changed in accordance with the instruction information of the degree of recognition. Further, the cognitive parameter is a value representing the degree of recognition of the change from the input object 3 to the reference object 5. Use of the data relating to the change object 4 or the cognitive parameter makes it possible to provide content in which display contents change without being noticed by the user.

### Other Embodiments

The present technology is not limited to the embodiment described above and can achieve various other embodiments.

In the above embodiment, the case where a face image of a human is used as a visual object has been mainly described. The present technology can also be applied not only to face images but also to videos, computer graphics (CG), and graphics such as logomarks of ordinary objects. In this case, a latent space relating to a visual object, to which a processing target belongs, is configured, and a latent cognitive scale in that latent space is configured. This makes it possible to generate a change object whose change is difficult to notice, or to present a parameter representing a cognitive distance or the like, for various visual objects.

In the above embodiment, the application tool (authoring tool or video communication tool) associated with the processing of outputting the data relating to the change object has been mainly described. The present technology is not limited to the above. For example, an application tool or the like that does not output the data relating to the change object may be configured. For example, a tool for outputting a cognitive distance between two images (the degree of recognition of a change associated with switching between two images) may be configured on the basis of the latent cognitive scale.

Use of such a tool makes it possible to support selection of an image to be replaced, for example, when the image is replaced without being noticed by another person. This makes it possible to correct display contents such as advertisements performed on a television or the Internet without being noticed.

Further, use of the tool for outputting a cognitive distance makes it possible to easily construct, for example, a data set for machine learning in which images and a cognitive distance are associated with each other.

In recent years, various visual correction tools using deep learning or the like have been proposed. Applying the present technology to such a tool makes it possible to construct a learning model that learns how much visual correction is likely to be recognized by a human. As a result, for example, it is possible to accurately provide information on the degree to which a change due to the correction is recognized, for the visual correction such as changing the shape of a face, changing the race or gender, and updating an apparent age.

In the above description, the case where the computer of the content generation system operated by the user executes the information processing method according to the present technology has been described. However, the information processing method and the program according to the present technology may be executed by a computer mounted in the content generation system and another computer communicable via a network or the like.

In other words, the information processing method and the program according to the present technology can be executed not only in a computer system including a single computer but also in a computer system in which a plurality of computers operates in conjunction with each other. Note that, in the present disclosure, a system means a collection of a plurality of constituent elements (apparatuses, modules (components), and the like), and whether or not all the constituent elements are in the same housing is not limited. Therefore, a plurality of apparatuses accommodated in separate housings and connected to each other through a network, and a single apparatus in which a plurality of modules is accommodated in a single housing are both the system.

The execution of the information processing method and the program according to the present technology by a computer system include, for example, both a case where the processing of acquiring the input object and the processing of calculating the change object or the cognitive parameter are executed by a single computer and a case where each process is executed by a different computer. Further, the execution of each process by a predetermined computer includes causing another computer to execute a part or all of the processes and acquiring a result thereof.

In other words, the information processing method and the program according to the present technology are also applicable to a configuration of cloud computing in which a single function is shared and cooperatively processed by a plurality of apparatuses through a network.

At least two of the characteristic portions according to the present technology described above can be combined. In other words, the various characteristic portions described in each embodiment may be arbitrarily combined without distinguishing between the embodiments. Further, the various effects described above are not limitative but are merely illustrative, and other effects may be provided.

In the present disclosure, “same”, “equal”, “orthogonal”, and the like are concepts including “substantially the same”, “substantially equal”, “substantially orthogonal”, and the like. For example, the states included in a predetermined range (e.g., range of ±10%) with reference to “completely the same”, “completely equal”, “completely orthogonal”, and the like are also included.

Note that the present technology may also take the following configurations.

(1) An information processing apparatus, including:
an acquisition unit that acquires data relating to an input object as a visual object; and
an output unit that outputs, on the basis of a model representing a relationship between a distance in a latent space relating to the visual object and a degree of recognition with respect to a change of the visual object based on the distance, at least one of data relating to at least one change object in which the input object is changed in the latent space in accordance with instruction information including an instruction value relating to the degree of recognition, or a cognitive parameter representing the degree of recognition with respect to a change from the input object to a reference object corresponding to the input object.

(2) The information processing apparatus according to (1), in which
the instruction value is a threshold of the degree of recognition,
the at least one change object is an object switched for display in a predetermined order instead of the input object, and
the output unit sets a distance in the latent space, which corresponds to an amount of change of a visual change caused by switching the change object for display, such that the degree of recognition with respect to the visual change caused by switching the change object for display does not exceed the threshold of the degree of recognition.

(3) The information processing apparatus according to (2), in which
the output unit sets the distance in the latent space, which corresponds to the amount of change, to a maximum value in a range in which the degree of recognition with respect to the visual change caused by switching the change object for display does not exceed the threshold of the degree of recognition.

(4) The information processing apparatus according to (2) or (3), in which
the predetermined order is an order of a shorter distance in the latent space between the input object and the change object.

(5) The information processing apparatus according to any one of (2) to (4), in which
the output unit calculates the data relating to the at least one change object in which the input object is changed to approach the reference object corresponding to the input object in the latent space.

(6) The information processing apparatus according to any one of (2) to (5), in which
the instruction information includes information for instructing a change direction, in which the input object is changed, in the latent space, and
the output unit calculates the data relating to the at least one change object in which the input object is changed along the change direction in the latent space.

(7) The information processing apparatus according to (6), in which
the latent space is a feature amount space configured by at least one feature amount relating to the visual object, and
the instruction information is information for instructing the change direction by the at least one feature amount.

(8) The information processing apparatus according to any one of (2) to (7), further including
a display control unit that
   controls a display apparatus to display a target object to be displayed in the input object and the at least one change object,
   detects a state in which visual change blindness is caused to a user who views the target object, and
   controls the display apparatus to change the target object to the change object to be displayed next in accordance with a timing at which the visual change blindness has been caused.

(9) The information processing apparatus according to (8), in which
the state in which the visual change blindness is caused includes at least one of a state in which the user closes an eye, a state in which the target object is inhibited from being displayed, or a state in which a display parameter of the target object is changed.

(10) The information processing apparatus according to any one of (1) to (9), in which
the output unit outputs, as the cognitive parameter, a change detection rate with respect to an overall visual change caused by changing the input object to the reference object.

(11) The information processing apparatus according to (10), in which
the output unit outputs a first change detection rate with respect to a visual change associated with first change processing of changing the input object to the reference object at one time.

(12) The information processing apparatus according to (10) or (11), in which
the output unit outputs a second change detection rate with respect to a visual change associated with second change processing including a plurality of division change processes of changing the input object to the reference object a plurality of times.

(13) The information processing apparatus according to (12), in which
the output unit multiplies a division change detection rate with respect to a visual change associated with each of the plurality of division change processes, to calculate the second change detection rate.

(14) The information processing apparatus according to (12) or (13), in which
the acquisition unit acquires a threshold of the second change detection rate, and
the output unit sets the number of times of the plurality of division change processes and an amount of change in each of the plurality of division change processes such that the second change detection rate is equal to or smaller than the threshold of the second change detection rate.

(15) The information processing apparatus according to any one of (10) to (14), in which
the reference object is an object input by a user or an object obtained by changing the input object in accordance with an amount of change input by the user.

(16) The information processing apparatus according to any one of (1) to (15), in which
the model includes a plurality of pieces of graph data each indicating the degree of recognition with respect to the change of the visual object based on the distance in the latent space in each of change directions mutually different in the latent space.

(17) The information processing apparatus according to (16), in which
the plurality of pieces of graph data includes data generated for each of human characteristics, and
the output unit selects data matched with a characteristic of a user from the plurality of pieces of graph data.

(18) An information processing method, which is executed by a computer system, the information processing method including:
acquiring data relating to an input object as a visual object; and
outputting, on the basis of a model representing a relationship between a distance in a latent space relating to the visual object and a degree of recognition with respect to a change of the visual object based on the distance, at least one of data relating to at least one change object in which the input object is changed in the latent space in accordance with instruction information including an instruction value relating to the degree of recognition, or a cognitive parameter representing the degree of recognition with respect to a change from the input object to a reference object corresponding to the input object.

(19) A computer-readable recording medium, on which a program causing a computer to execute processing is recorded, the processing including the steps of:
acquiring data relating to an input object as a visual object; and
outputting, on the basis of a model representing a relationship between a distance in a latent space relating to the visual object and a degree of recognition with respect to a change of the visual object based on the distance, at least one of data relating to at least one change object in which the input object is changed in the latent space in accordance with instruction information including an instruction value relating to the degree of recognition, or a cognitive parameter representing the degree of recognition with respect to a change from the input object to a reference object corresponding to the input object.

(20) A model generating method, including:
generating data relating to each of a first visual object and a second visual object that are represented by different points in a latent space relating to a visual object;
acquiring data in which a determination result of a test is associated with a distance between the points representing the first visual object and the second visual object in the latent space, the test being for allowing a tester to determine presence or absence of a cognitive difference between the first visual object and the second visual object or a degree of the cognitive difference; and
generating a model representing a relationship between the distance in the latent space and a degree of recognition with respect to a change of the visual object based on the distance on the basis of the acquired data.

### REFERENCE SIGNS LIST

1 user
2 visual object
3 input object
4 change object
5 reference object
6a to 6c test object
10 visual content
20 display
24 storage unit
25 controller
26 data acquisition unit
27 object processing unit
28 display control unit
40 latent space
41 change direction
45 latent cognitive scale
46 scale graph
100 content generation system

1. An information processing apparatus, comprising:
an acquisition unit that acquires data relating to an input object as a visual object; and
an output unit that outputs, on a basis of a model representing a relationship between a distance in a latent space relating to the visual object and a degree of recognition with respect to a change of the visual object based on the distance, at least one of data relating to at least one change object in which the input object is changed in the latent space in accordance with instruction information including an instruction value relating to the degree of recognition, or a cognitive parameter representing the degree of recognition with respect to a change from the input object to a reference object corresponding to the input object.

2. The information processing apparatus according to claim 1, wherein
the instruction value is a threshold of the degree of recognition,
the at least one change object is an object switched for display in a predetermined order instead of the input object, and
the output unit sets a distance in the latent space, which corresponds to an amount of change of a visual change caused by switching the change object for display, such that the degree of recognition with respect to the visual change caused by switching the change object for display does not exceed the threshold of the degree of recognition.

3. The information processing apparatus according to claim 2, wherein
the output unit sets the distance in the latent space, which corresponds to the amount of change, to a maximum value in a range in which the degree of recognition with respect to the visual change caused by switching the change object for display does not exceed the threshold of the degree of recognition.

4. The information processing apparatus according to claim 2, wherein
the predetermined order is an order of a shorter distance in the latent space between the input object and the change object.

5. The information processing apparatus according to claim 2, wherein
the output unit outputs the data relating to the at least one change object in which the input object is changed to approach the reference object corresponding to the input object in the latent space.

6. The information processing apparatus according to claim 2, wherein
the instruction information includes information for instructing a change direction, in which the input object is changed, in the latent space, and
the output unit outputs the data relating to the at least one change object in which the input object is changed along the change direction in the latent space.

7. The information processing apparatus according to claim 6, wherein
the latent space is a feature amount space configured by at least one feature amount relating to the visual object, and
the instruction information is information for instructing the change direction by the at least one feature amount.

8. The information processing apparatus according to claim 2, further comprising
a display control unit that
controls a display apparatus to display a target object to be displayed in the input object and the at least one change object,
detects a state in which visual change blindness is caused to a user who views the target object, and
controls the display apparatus to change the target object to the change object to be displayed next in accordance with a timing at which the visual change blindness has been caused.

9. The information processing apparatus according to claim 8, wherein
the state in which the visual change blindness is caused includes at least one of a state in which the user closes an eye, a state in which the target object is inhibited from being displayed, or a state in which a display parameter of the target object is changed.

10. The information processing apparatus according to claim 1, wherein
the output unit outputs, as the cognitive parameter, a change detection rate with respect to an overall visual change caused by changing the input object to the reference object.

11. The information processing apparatus according to claim 10, wherein
the output unit outputs a first change detection rate with respect to a visual change associated with first change processing of changing the input object to the reference object at one time.

12. The information processing apparatus according to claim 10, wherein
the output unit outputs a second change detection rate with respect to a visual change associated with second change processing including a plurality of division change processes of changing the input object to the reference object a plurality of times.

13. The information processing apparatus according to claim 12, wherein
the output unit multiplies a division change detection rate with respect to a visual change associated with each of the plurality of division change processes, to calculate the second change detection rate.

14. The information processing apparatus according to claim 12, wherein
the acquisition unit acquires a threshold of the second change detection rate, and
the output unit sets the number of times of the plurality of division change processes and an amount of change in each of the plurality of division change processes such that the second change detection rate is equal to or smaller than the threshold of the second change detection rate.

15. The information processing apparatus according to claim 10, wherein
the reference object is an object input by a user or an object obtained by changing the input object in accordance with an amount of change input by the user.

16. The information processing apparatus according to claim 1, wherein
the model includes a plurality of pieces of graph data each indicating the degree of recognition with respect to the change of the visual object based on the distance in the latent space in each of change directions mutually different in the latent space.

17. The information processing apparatus according to claim 16, wherein
the plurality of pieces of graph data includes data generated for each of human characteristics, and
the output unit selects data matched with a characteristic of a user from the plurality of pieces of graph data.

18. An information processing method, which is executed by a computer system, the information processing method comprising:
acquiring data relating to an input object as a visual object; and
outputting, on a basis of a model representing a relationship between a distance in a latent space relating to the visual object and a degree of recognition with respect to a change of the visual object based on the distance, at least one of data relating to at least one change object in which the input object is changed in the latent space in accordance with instruction information including an instruction value relating to the degree of recognition, or a cognitive parameter representing the degree of recognition with respect to a change from the input object to a reference object corresponding to the input object.

19. A computer-readable recording medium, on which a program causing a computer to execute processing is recorded, the processing comprising the steps of:
acquiring data relating to an input object as a visual object; and
outputting, on a basis of a model representing a relationship between a distance in a latent space relating to the visual object and a degree of recognition with respect to a change of the visual object based on the distance, at least one of data relating to at least one change object in which the input object is changed in the latent space in accordance with instruction information including an instruction value relating to the degree of recognition, or a cognitive parameter representing the degree of recognition with respect to a change from the input object to a reference object corresponding to the input object.

20. A model generating method, comprising:
generating data relating to each of a first visual object and a second visual object that are represented by different points in a latent space relating to a visual object;
acquiring data in which a determination result of a test is associated with a distance between the points representing the first visual object and the second visual object in the latent space, the test being for allowing a tester to determine presence or absence of a cognitive difference between the first visual object and the second visual object or a degree of the cognitive difference; and
generating a model representing a relationship between the distance in the latent space and a degree of recognition with respect to a change of the visual object based on the distance on a basis of the acquired data.
